(19) United States
(12) Patent Application Publication
(10) Pub. No.: US 2025/0240595 A1
(43) Pub. Date: Jul. 24, 2025

(54) SOUND PROCESSING METHOD, SOUND PROCESSING DEVICE, AND SOUND PROCESSING PROGRAM

(71) Applicant: Yamaha Corporation, Hamamatsu (JP)

(72) Inventors: Katsumi ISHIKAWA, Hamamatsu (JP); Futoshi SHIRAKIHARA, Hamamatsu (JP); Kentaro NOTO, Hamamatsu (JP); Daichi ISERI, Fukuroi-shi (JP); Akio OHTANI, Tokyo (JP); Tadashi MORIKAWA, Hamamatsu (JP)

(21) Appl. No.: 19/177,019

(22) Filed: Apr. 11, 2025

Related U.S. Application Data
(63) Continuation of application No. PCT/JP2023/030523, filed on Aug. 24, 2023.

(30) Foreign Application Priority Data
Oct. 13, 2022 (JP) 2022-164700

(51) Int. Cl. H04S 7/00

(52) U.S. Cl. CPC H04S 7/304

(57) ABSTRACT

A sound processing method includes receiving sound information containing a sound signal of a sound source and position information of the sound source, applying, to the sound signal of the sound source, a first localization process in which a sound image of a direct sound of the sound source is localized based on the position information of the sound source, applying, to the sound signal of the sound source, a second localization process in which the sound image of an indirect sound of the sound source is localized based on the position information of the sound source, receiving a condition related to the sound source or a space, and selecting object-based processing or channel-based processing based on the condition to apply the second localization process.

### CROSS-REFERENCE TO RELATED APPLICATIONS

This application is a continuation application of International Application No. PCT/JP2023/030523, filed on Aug. 24, 2023, which claims priority to Japanese Patent Application No. 2022-164700 filed in Japan on Oct. 13, 2022. The entire disclosures of International Application No. PCT/JP2023/030523 and Japanese Patent Application No. 2022-164700 are hereby incorporated herein by reference.

### BACKGROUND

### Technical Field

One embodiment of this disclosure relates to a sound processing method, a sound processing device, and a sound processing program.

### Background Information

International Publication No. 2022/4421 discloses an information processing device that outputs channel-based sound from a speaker and outputs object-based sound from headphones.

### SUMMARY

The information processing device disclosed in International Publication No. 2022/4421 is for carrying out processing related to localization of direct sounds and is not for carrying out processing related to localization of indirect sounds, such as reflected sounds in a room.

When listening to sounds of a sound source through headphones, it is important to localize sound images of indirect sounds in order to recreate reverberations of a prescribed space. However, when the number of indirect sounds increases, the amount of computation becomes immense, and appropriate sound image localization processing of indirect sounds becomes impossible. Therefore, a user cannot obtain the optimal reverberation experience.

An object of one embodiment of this disclosure is to provide a sound processing method that realizes appropriate sound image localization processing of indirect sounds so that users can obtain the optimal reverberation experience.

A sound processing method according to one embodiment of this disclosure comprises: receiving sound information containing a sound signal of a sound source and position information of the sound source; applying, to the sound signal of the sound source, a first localization process in which a sound image of a direct sound of the sound source is localized based on the position information of the sound source; applying, to the sound signal of the sound source, a second localization process in which the sound image of an indirect sound of the sound source is localized based on the position information of the sound source; receiving a condition related to the sound source or a space; and selecting object-based processing or channel-based processing based on the condition to apply the second localization process.

### BRIEF DESCRIPTION OF THE DRAWINGS

FIG. 1 is a block diagram showing a configuration of a sound processing device 1.

FIG. 2 is a block diagram showing a functional configuration of a processor 12.

FIG. 3 is a flowchart showing an operation of a sound processing method executed by the processor 12.

FIG. 4 is a diagram showing one example of a tool screen (GUI) used when a content creator creates content.

FIG. 5 is a schematic diagram showing the positional relationship between a sound source and a listener.

FIG. 6 is a schematic diagram showing the positional relationship between a sound source and a listener.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

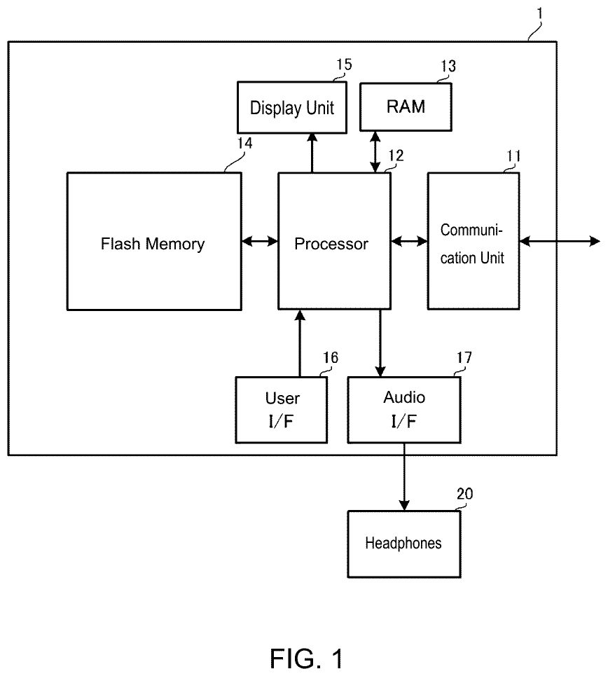

FIG. 1 is a block diagram showing a configuration of a sound processing device 1. The sound processing device 1 is realized by an information processing device such as a personal computer (PC), a smartphone, a set-top box, or an audio receiver. The sound processing device 1 is connected to headphones 20.

The sound processing device 1 receives content-related sound information from a content distribution device such as a server and reproduces the sound information. Contents include sound information such as music, plays, musicals, lectures, book readings, games, and the like. The sound processing device 1 reproduces direct sounds of a sound source contained in these pieces of sound information, and reverberations (indirect sounds) of a space related to the content.

The sound processing device 1 comprises a communication unit 11, a processor 12, RAM (Random Access Memory) 13, flash memory 14, a display unit 15, a user I/F (Interface) 16, and an audio I/F (Interface) 17.

The communication unit 11 has a wireless communication function such as Bluetooth (registered trademark) or Wi-Fi (registered trademark), or a wired communication function such as USB (Universal Serial Bus) or LAN (Local Area Network). The communication unit 11 can be a transmitter, a transceiver, or a transmitter-receiver capable of transmitting and/or receiving sound signals via a wireless or wired communication.

The display unit 15 is a display such as an LCD (Liquid-Crystal display), and/or an OLED (Organic Light Emitting Diode). The display unit 15 displays an image output by the processor 12. If the content distributed from the content distribution device contains video information, the processor 12 plays the video information and displays video related to the content on the display unit 15.

The user I/F 16 is one example of an operation unit. The user I/F 16 is a user operable input such as a mouse, a keyboard, a touch panel, and/or the like. The user I/F 16 receives operations from the user. The touch panel can be layered on the display unit 15.

The audio I/F 17 has a wireless communication function such as Bluetooth (registered trademark) or Wi-Fi (registered trademark), an analog or digital audio terminal, or the like, which connects audio devices. In the present embodiment, the sound processing device 1 is connected to the headphones 20 and outputs sound signals to the headphones 20.

The processor 12 is a processor such as a CPU (Central Processing Unit), a DSP (Digital Signal Processor), a SoC (System on a Chip), and/or the like. The processor 12 is one example included in an electronic controller of the sound processing device 1, and the electronic controller can be configured to comprise one or more processors. Here, the term “electronic controller” as used herein refers to hardware, and does not include a human. The processor 12 reads a program from the flash memory 14, which is a storage medium, and temporarily stores the program in the RAM 13 to carry out various operations. It is not necessary for the program to be stored in the flash memory 14. The processor 12 can, for example, download a program from another device, such as a server, when needed, and temporarily store the program in the RAM 13. A computer memory such as RAM 13 and/or flash memory 14 is one example of a non-transitory computer-readable medium.

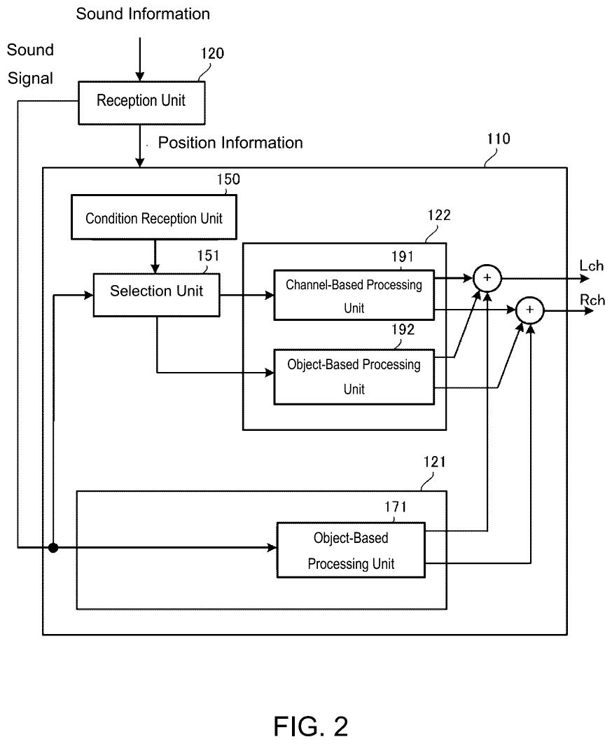

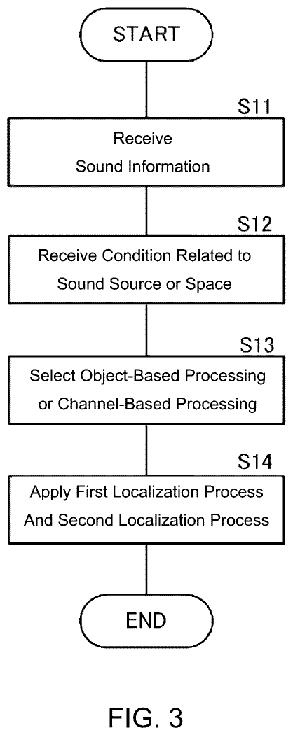

FIG. 2 is a block diagram showing a functional configuration of the processor 12. FIG. 3 is a flowchart showing an operation of a sound processing method executed by the processor 12. The processor 12 functionally realizes the configuration shown in FIG. 2 using a program read from the flash memory 14.

The processor 12 functionally includes a reception unit 120 and a signal processing unit 110. The signal processing unit 110 has a condition reception unit 150, a selection unit 151, a first localization processing unit 121, and a second localization processing unit 122. The first localization processing unit 121 has an object-based processing unit 171. The second localization processing unit 122 has a channel-based processing unit 191 and an object-based processing unit 192.

The reception unit 120 receives, via the communication unit 11, content-related sound information from a content distribution device such as a server (S11). The sound information includes a sound signal of a sound source and position information of the sound source. The sound source refers to singing sounds, speaking voices, performance sounds, sound effects, environmental sounds, etc., which constitute the content.

The sound information of the present embodiment is in accordance with an object-based method. An object-based method is a method in which sound signals and position information are independently stored for each sound source. In contrast, a channel-based method is a method in which sound signals for each sound source are pre-mixed and stored in the sound signals of one or more channels.

The reception unit 120 extracts, from the received sound information, a sound signal and position information for each sound source. Then, the condition reception unit 150 receives a condition related to the sound source or a space (S12).

The condition related to a sound source is an attribute of the sound source, a static characteristic of the sound source, or a dynamic characteristic of the sound source. The attribute of the sound source is, for example, information related to the type of the sound source (singing sound, speaking sound, performance sound, sound effect, environmental sound, or the like) or to the importance of the sound source. The static characteristic of the sound source is, for example, information related to the volume or frequency characteristics of the sound source. The dynamic characteristic of the sound source is, for example, information related to the distance between the position of the sound source and the position of a listening point or to the amount of movement of the sound source.

The condition of a space is an attribute of the space, a static characteristic of the space, or a dynamic characteristic of the space. The attribute of the space is information related to the type of the space (room, hall, stadium, studio, church, or the like) or to the importance of the space. The static characteristic of the space is information related to the number of reverberations (number of reflected sounds) of the space. The dynamic characteristic of the space is information related to the distance between the positions of wall surfaces defining the space and the position of the listening point.

Such conditions related to the sound source or to the space can be received at the sound processing device 1 that plays the content from a user of the sound processing device 1 via the user I/F 16. Alternatively, the content creator can use a prescribed tool when creating content to specify a condition for each sound source or each space.

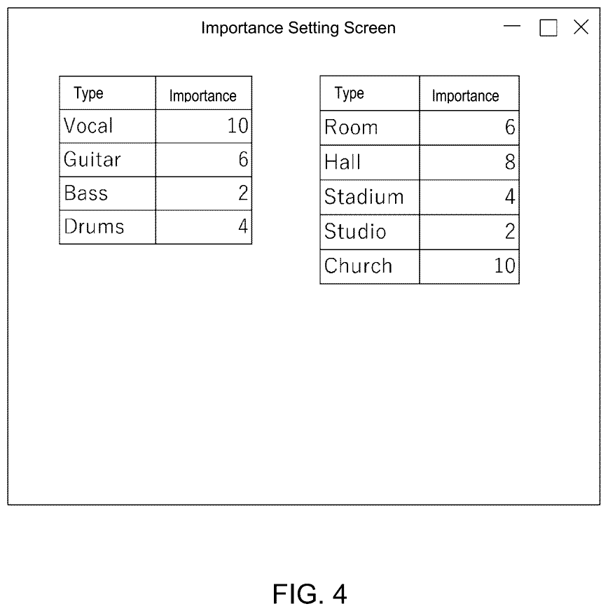

FIG. 4 is a diagram showing one example of a tool screen (GUI (Graphical User Interface)) used when a content creator creates content. In the GUI of the tool shown in FIG. 4, the content creator can set the type and importance for each sound source. Such settings can be carried out for each piece of content, or for each scenario within the content. In addition, in the GUI of the tool shown in FIG. 4, the content creator can set the type and importance for each space. The information related to the type and importance of the sound source or the space that have been set is stored in the sound information of the content and distributed to a reproduction device, such as the sound processing device 1. The condition reception unit 150 extracts the information related to the type and importance of the sound source and/or of the space, the information being stored in the sound information of the content, and receives one or more conditions related to the sound source and/or the space.

Next, the selection unit 151 selects either object-based processing or channel-based processing for the localization process to be applied to indirect sounds, based on the condition(s) received by the condition reception unit 150 (S13). In the present embodiment, as an example, the selection unit 151 selects either object-based processing or channel-based processing based on the importance of the sound source included in the sound information of the content.

Then, the processor 12 applies, based on the position information for each sound source, to the sound signal of the sound source, a first localization process for localizing the sound images of the direct sounds of the sound source by object-based processing, and a second localization process for localizing the sound images of the indirect sounds of the sound source by either object-based processing or channel-based processing (S14). However, the first localization process can be carried out by channel-based processing.

The object-based processing is processing based on Head Related Transfer Function (HRTF), for example. HRTF represents a transfer function extending from the position of the sound source to the left and right ears of the listener.

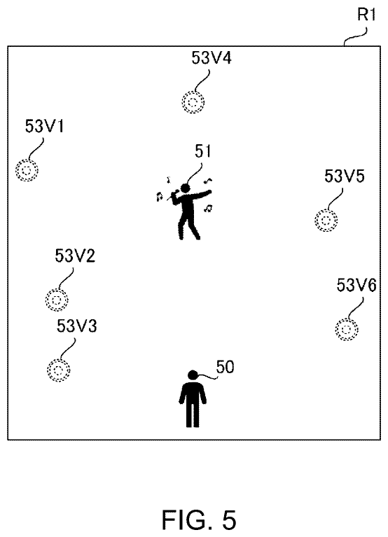

FIG. 5 is a schematic diagram showing the positional relationship between a listener 50 and a sound source 51 in a certain space R1. In the present embodiment, a two-dimensional space R1 is shown in plan view as an example, but the space can be two-dimensional or three-dimensional. The position information of the sound source 51 is expressed as two-dimensional or three-dimensional coordinates based on a prescribed position in the space R1, or two-dimensional or three-dimensional coordinates based on the position of the listener 50. In addition, the position information of the sound source 51 is expressed as chronological two-dimensional or three-dimensional coordinates corresponding to the elapsed time from the start of content reproduction. Some sound sources do not change the position from the start to end of reproduction, while some sound sources change positions over time, like a performer.

Information on the space R1 is information indicating the shape of a three-dimensional space corresponding to a prescribed venue, such as a live music venue or a concert hall, and is expressed as three-dimensional coordinates with a certain position serving as the origin. Spatial information can be coordinate information based on 3D CAD data of an actual venue, such as a concert hall, or can be logical coordinate information of a fictitious venue (information normalized between 0 and 1). The position information of a space can include world coordinates and local coordinates. For example, in game content, a plurality of local spaces exist in a virtual world space.

The information on the space and the position of the listener can be pre-specified with a tool, such as the above-mentioned GUI, by the content creator, or can be specified by a user of the sound processing device 1 via the user I/F 16. In game content, the user moves a character object (position of the listener) inside a virtual world space via the user I/F 16.

In the example shown in FIG. 5, the position of the singer's sound source 51 is a prescribed distance away from the directly front as viewed from the listener 50. The object-based processing unit 171 of the first localization processing unit 121 carries out binaural processing to convolve, with the sound signal corresponding to the singer's sound source 51, an HRTF that causes the sound signal to be localized at a prescribed distance away directly in front of the listener 50. More specifically, the object-based processing unit 171 convolves an HRTF extending from the position of the sound source 51 to the right ear of the listener 50 with the sound signal of the sound source 51, thereby generating a sound signal of the R channel. In addition, the object-based processing unit 171 convolves an HRTF extending from the position of the sound source 51 to the left ear of the listener 50 with the sound signal of the sound source 51, thereby generating a sound signal of the L channel. These L-channel and R-channel sound signals are output to the headphones 20 via the audio I/F 17. The user of the sound processing device 1 listens to the sounds of the L channel and the R channel through the headphones 20.

As a result, the user of the sound processing device 1 is able to perceive sound as if the user is at the position of the listener 50 in the space R1, the singer is directly in front of the user, and the user is listening to the singing sounds corresponding to the sound source 51.

The second localization processing unit 122 carries out the second localization process for localizing the sound images of indirect sounds of the singer's sound source 51 by either object-based processing or channel-based processing. FIG. 5 shows an example in which, as sound images of indirect sounds, six reflected sounds 53V1 to 53V6 are localized on the wall surfaces of the space R1 by object-based processing.

When the selection unit 151 selects object-based processing, the object-based processing unit 192 carries out a process of convolving an HRTF with the sound signal of the singer's sound source 51, based on the positions of the reflected sounds 53V1 to 53V6. The object-based processing unit 192 calculates the positions of the reflected sounds as viewed from the listening point based on for example the position of the sound source, the positions of the wall surfaces of the venue based on 3D CAD data, etc., and the position of the listening point, and convolves an HRTF for localizing the sound images to the positions of the reflected sounds with the sound signal of the sound source. That is, in this case, the object-based processing unit 192 carries out convolution processing of six HRTFs. The positions of the reflected sounds 53V1 to 53V6 can be acquired by measuring impulse responses using a plurality of microphones at a certain venue (for example, an actual live music venue).

The user of the sound processing device 1 can thereby clearly perceive the reverberation of the sound source 51 in the space R1.

On the other hand, the amount of computation increases as the number of reflected sounds increases. In the example of FIG. 5, a case is shown in which six reflected sounds are localized for the purpose of explanation; however, the number of reflected sounds in an actual space can be several tens or even several hundreds.

Therefore, in the sound processing device 1 of the present embodiment, the selection unit 151 selects either the object-based processing or the channel-based processing based on a condition related to the sound source or to the space. In the example of the present embodiment, the selection unit 151 selects either the object-based processing or the channel-based processing based on the importance of the sound source or the importance of the space. For example, the selection unit 151 selects the object-based processing for a sound source or a space that is greater than or equal to a prescribed threshold (for example, an importance of 6). For example, in the example of FIG. 4, the selection unit 151 selects the object-based processing for sound sources with an importance of 10 (vocal) and with an importance of 6 (guitar). Alternatively, the selection unit 151 selects the object-based processing when the specified space has an importance of 10 (church), an importance of 8 (hall), or an importance of 6 (room), as shown in FIG. 4. As described above, information on a space can be pre-specified by the content creator, or can be specified by the user of the sound processing device 1 via the user I/F 16. For example, even if the content creator pre-specifies a church space, if the user of the sound processing device 1 specifies a studio space having an importance of 2, the selection unit 151 can determine that the importance is less than the threshold and select the channel-based processing. Alternatively, when the content includes a plurality of spaces, such as in games, if the user moves a character object (position of the listener) in a virtual world space via the user I/F 16 from one space (for example, a church) to another space (for example, a studio), the selection unit 151 switches from a state in which the object-based processing is selected to a state in which the channel-based processing is selected.

The channel-based processing is processing for distributing sound signals pertaining to a plurality of reflected sounds to a plurality of channels (to the Land R channels in the present embodiment) at a prescribed level ratio. The channel-based processing unit 191 calculates the direction of arrival of the reflected sound based on the position information of the reflected sound and the position of the listening point. Then, the channel-based processing unit 191 distributes the sound signal of the sound source to the Land R channels at a level ratio based on the direction of arrival. For example, if distributed at the same level to the L and R channels, the user will obtain a sense of localization of the sound source at the center in the left-right direction. As the level of the sound signal in the R channel increases, the user obtains a sense of localization of the sound source that is farther to the right. As the level of the sound signal in the L channel increases, the user obtains a sense of localization of the sound source that is farther to the left.

In addition, the channel-based processing unit 191 can calculate the distance between the positions of the listening point and the reflected sound, based on the position information of the reflected sound and the position of the listening point. The channel-based processing unit 191 can distribute and impart, to the sound signal of the sound source, a delay based on the calculated distance. As the amount of delay increases, the user obtains a sense of localization of the sound source that is farther away. As the amount of delay decreases, the user obtains a sense of localization of the sound source that is closer. In this manner, the channel-based processing unit 19 can impart a delay to provide a sense of distance.

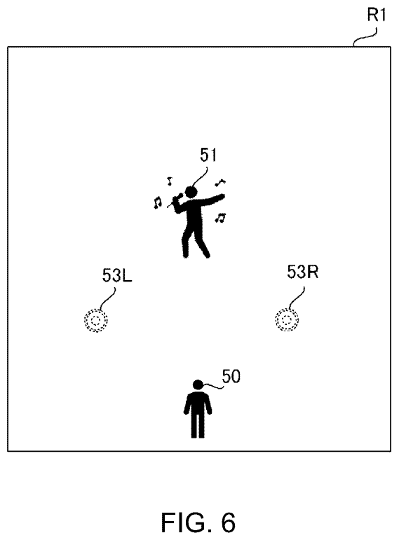

It should be noted that the sound processing device 1 can carry out a processing to respectively convolve an HRTF with sound signals after the sound signal are distributed to the Land R channels. FIG. 6 is a schematic diagram showing the positional relationship between a sound source and a listener. The HRTF in this case corresponds to a transfer function by which sound images are localized at the positions of an L channel speaker 53L on the left side and an R channel speaker 53R on the right side, in front of the listener 50, for example. As a result, a user listening to reflected sounds through the headphones 20 is able to perceive the L-channel and R-channel sounds as if the sounds are being reproduced from speakers virtually existing to the left and right, in front of and away from the head. The channel-based processing unit 191 can add the delay described above, in a state in which sound is perceived as if being reproduced from such virtual speakers, to cause the user to feel a strong sense of distance from the reflected sounds, thereby improving the sense of localization of indirect sounds.

In addition, the number of channels in this example is two, but the number of channels is not limited to two. For example, the channels can include surround channels behind the listener, or height channels in the height direction. The channel-based processing unit 191 can distribute the sound signal to the surround channels or to the height channels. The channel-based processing unit 191 can carry out processing of respectively convolving an HRTF with sound signals after the sound signal have been distributed. The HRTF in this case corresponds to a transfer function by which sound images are localized at the positions of speakers corresponding to the surround channel or to the height channel. As a result, a user listening to reflected sounds through the headphones 20 is also able to perceive sounds as if the sounds are being reproduced from speakers virtually existing behind or above and away from the head.

In the channel-based processing, a plurality of reflected sounds are distributed to the sound signals of the Land R channels, and a large number of complex filter processes are not carried out, as would be the case with the object-based processing. Even when carrying out the HRTF convolution processing in which sound images are localized at the positions of the L channel speaker 53L and the R channel speaker 53R as described above, for example, if ten reflected sounds are distributed to the Land R channels, the HRTF convolution processing load is reduced to 1/10. Therefore, in the channel-based processing, even if the number of reflected sounds becomes immense, the amount of computation can be significantly suppressed compared to the object-based processing.

Then, in the example above, the content creator sets the importance for each sound source or for each space, in consideration of the importance of the indirect sounds for each sound source or for each space. For example, a sound source related to voice, such as singing sounds and dialogue, tend to attract much attention from the listener, thus the importance of the indirect sounds is also high. Therefore, the content creator sets high importance to sound sources related to voice, such as singing sounds and dialogue. On the other hand, sound sources other than voice (particularly sounds of low-pitched musical instruments such as the bass) tend to attract less attention from the listener, so the importance of the indirect sounds is also low. Therefore, the content creator sets low importance to sound sources other than voice.

Alternatively, importance of indirect sounds becomes high in distinctive spaces with much reverberation, such as a hall or a church. Therefore, the content creator sets high importance to distinctive spaces with much reverberation, such as a hall or a church. On the other hand, importance of indirect sounds becomes low in spaces with little reverberation, such as a studio. Therefore, the content creator sets low importance to spaces with little reverberation, such as a studio.

Alternatively, there are cases in which the content creator intentionally sets a high importance to a sound source or a space for which the creator wants the reverberation to be intentionally heard.

In the sound processing device 1 of the present embodiment, the object-based processing is selected for sound sources with high importance (the vocal and guitar sound sources in the example of FIG. 4) or for spaces with high importance (room, hall, and church in the example of FIG. 4), and the channel-based processing is selected for sound sources with low importance (the bass and drum sound sources in the example of FIG. 4) or for spaces with low importance (stadium and studio in the example of FIG. 4), thereby making it possible to provide the optimal reverberation experience to the user while suppressing the amount of computation.

### First Modified Example

The sound processing device 1 according to the first modified example selects either the object-based processing or the channel-based processing based on the type of the sound source. The type of a sound source is specified by the content creator, for example as shown in FIG. 4. Alternatively, the sound processing device 1 can analyze the sound signal and determine the type of the sound source.

In the first modified example, the selection unit 151 selects either the object-based processing or the channel-based processing based on the type of the sound source.

For example, the selection unit 151 selects the object-based processing when the sound source type is related to voice, such as singing sounds and dialogue sounds. In addition, the selection unit 151 selects the channel-based processing when the sound source type is other than voice.

In addition, the selection unit 151 selects the object-based processing when the sound source type is related to sound effects. In addition, the selection unit 151 selects the channel-based processing when the sound source type is related to environmental sounds.

As a result, it becomes easy for the user of the sound processing device 1 to perceive reverberation of types of sound sources that attract much attention. In addition, the amount of computation can be significantly suppressed for types of sound sources that attract less attention by using the channel-based processing. Accordingly, the sound processing device 1 of the first modified example can provide the optimal reverberation experience to users while suppressing the amount of computation.

### Second Modified Example

In the second modified example, the selection unit 151 selects either the object-based processing or the channel-based processing based on the type of the space. The type of a space can be pre-specified with a tool, such as a GUI, by the content creator as shown in FIG. 4, or can be specified by a user of the sound processing device 1 via the user I/F 16. For example, when listening to the content of a particular concert, the user of the sound processing device 1 can change the type of venue from a hall to a room, or to a church, etc., to experience different reverberations.

The selection unit 151 selects either the object-based processing or the channel-based processing based on the designated type of space. For example, the selection unit 151 selects the object-based processing when the type of space is distinctive and has much reverberation, such as a church or a hall. In addition, the selection unit 151 selects the channel-based processing when the type of space has little reverberation, such as a studio.

As a result, when playing content related to a type of space that is distinctive and has much reverberation, the user of the sound processing device 1 can more easily perceive the reverberation of the space and experience the space more realistically. Additionally, the amount of computation can be significantly suppressed when playing content related to a type of space with little reverberation. Accordingly, the sound processing device 1 of the second modified example can provide the optimal reverberation experience to users while suppressing the amount of computation.

### Third Modified Example

In the third modified example, the selection unit 151 selects either the object-based processing or the channel-based processing based on a static characteristic of the sound source.

The static characteristic of a sound source is information related to, for example, the volume or sound quality (frequency characteristic) of the sound source. The selection unit 151 selects the object-based processing when the sound source has a high volume (for example, having a level equal to or higher than a prescribed value). In addition, the selection unit 151 selects the channel-based processing when the sound source has low volume (for example, having a level lower than a prescribed value).

Additionally, the listener can feel a strong sense of direction regarding sounds in the high frequency band. Therefore, the selection unit 151 selects the object-based processing when the sound source has high levels in the high frequency band (for example, when the power of a band of greater than or equal to 1 kHz is a prescribed value or greater). The selection unit 151 selects the channel-based processing when the sound source has low levels in the high frequency band (for example, when the power of a band of greater than or equal to 1 kHz is lower than a prescribed value).

As a result, the user of the sound processing device 1 can clearly perceive reverberations of a sound source having a characteristic that attracts much attention. In addition, the amount of computation can be significantly suppressed for sound sources having a characteristic that attracts less attention by using channel-based processing. Accordingly, the sound processing device 1 of the third modified example can provide the optimal reverberation experience to users while suppressing the amount of computation.

### Fourth Modified Example

In the fourth modified example, the selection unit 151 selects either the object-based processing or the channel-based processing based on a dynamic characteristic of the sound source.

The dynamic characteristic of a sound source is, for example, information related to the distance between the position of the sound source and the position of a listening point, or to the amount of movement of the sound source. A sound source that is close to the listening point or that moves a large amount attracts more attention from the listener.

The selection unit 151 selects the object-based processing, for example, when the sound source is close by (the distance between the position of the sound source and the position of the listening point is a prescribed value or less). The selection unit 151 selects the channel-based processing when the sound source is far away (the distance between the position of the sound source and the position of the listening point is greater than a prescribed value).

In addition, the selection unit 151 selects the object-based processing, for example, when the sound source moves a large amount (the amount of movement per unit time is greater than or equal to a prescribed value). The selection unit 151 selects the channel-based processing, for example, when the sound source moves a small amount (the amount of movement per unit time is less than a prescribed value).

As a result, the user of the sound processing device 1 can clearly perceive reverberations of a sound source that attracts much attention. In addition, the amount of computation can be significantly suppressed for sound sources that attract less attention by using the channel-based processing. Accordingly, the sound processing device 1 of the fourth modified example can provide the optimal reverberation experience to users while suppressing the amount of computation.

### Fifth Modified Example

In the fifth modified example, the selection unit 151 selects either the object-based processing or the channel-based processing based on a static characteristic of the space.

The static characteristic of a space is information related to the number of reverberations (number of reflected sounds) of the space. The number of reflected sounds is determined by the reflectance of the wall surfaces that constitute the space, for example. When the reflectance of the wall surfaces is high, the number of reflected sounds increases. When the reflectance of the wall surfaces is low, the number of reflected sounds decreases. The selection unit 151 selects the object-based processing when the space has many reflected sounds (the reflectance of the wall surfaces is a prescribed value or higher). The selection unit 151 selects the channel-based processing when, for example, the space has few reflected sounds (the reflectance of the wall surfaces is less than a prescribed value).

As a result, when playing content related to a space with many reflected sounds, the user of the sound processing device 1 can more easily perceive the reverberation of the space and experience the space more realistically. Additionally, the amount of computation can be significantly suppressed when playing content related to a space with few reflected sounds. Accordingly, the sound processing device 1 of the fifth modified example can provide the optimal reverberation experience to users while suppressing the amount of computation.

### Sixth Modified Example

In the sixth modified example, the selection unit 151 selects either the object-based processing or the channel-based processing based on a dynamic characteristic of the space.

The dynamic characteristic of a space is information related to the distance between the positions of wall surfaces defining the space and the position of the listening point. The selection unit 151 selects the object-based processing when the positions of the listening point and the wall surface are close to each other (the distance between the position of the listening point and the position of the wall surface is less than or equal to a prescribed value). The selection unit 151 selects the channel-based processing when the positions of the listening point and the wall surface are far from each other (the distance between the position of the listening point and the position of the wall surface is greater than a prescribed value).

As a result, the listener can more easily perceive reverberations and clearly perceive reverberations of the space, when the listener is close to a wall surface and in a situation in which reflected sounds tend to attract attention. In addition, the amount of computation is significantly suppressed when the listener is far from a wall surface and the level of attention that the reflected sounds attracts is low. Accordingly, the sound processing device 1 of the sixth modified example can provide the optimal reverberation experience to users while suppressing the amount of computation.

### Seventh Modified Example

The sound processing device 1 according to the seventh modified example receives a condition related to the processing capacity of a device that carries out the second localization process, and selects either the object-based processing or the channel-based processing based on the processing capacity.

The processing capacity is, for example, the number of processor cores, the number of threads, the clock frequency, the cache capacity, the bus speed, the utilization rate, or the like, for the processor. The selection unit 151 selects the object-based processing when, for example, the number of processor cores, the number of threads, the clock frequency, the cache capacity, and the bus speed for the processor are respectively greater than or equal to prescribed values. The selection unit 151 selects the channel-based processing when the number of processor cores, the number of threads, the clock frequency, the cache capacity, and the bus speed for the processor are respectively less than prescribed values.

The selection unit 151 can select the object-based processing when the utilization rate of the processor is less than or equal to a prescribed value. The selection unit 151 can select the channel-based processing when the processor utilization rate is higher than a prescribed value. The processor utilization rate changes in accordance with the processing load of the device. In this case, the selection unit 151 dynamically switches the selection between the object-based processing and the channel-based processing in accordance with the processing load of the processor. Note that the threshold value for switching between the object-based processing and the channel-based processing can be specified by the user of the sound processing device 1. For example, when prioritizing power saving, the user specifies a low value for the threshold.

As a result, the sound processing device 1 of the seventh modified example can provide the optimal reverberation experience to users while suppressing the amount of computation.

### Eighth Modified Example

The sound information can include group information of a plurality of sound sources. More specifically, the sound information can include group information on one or more groups which a plurality of sound sources belong to. The content creator uses a prescribed tool when creating content to designate a plurality of sound sources as a certain group. The content creator specifies, for example, a sound source of a certain character's dialogue and one or more of sound sources of sound effects associated with said character, such as footsteps and the sounds of objects worn by said character, and/or the like, as being in the same group. The same condition is set for the plurality of sound sources designated to the same group.

For example, when the sound source is of a type related to voice or has high importance, the selection unit 151 selects the object-based processing for all sound sources belonging to the same group as said sound source.

As a result, the object-based processing is applied to all sound effects associated with sound sources that attract much attention. Accordingly, the sound processing device 1 of the eighth modified example can provide the optimal reverberation experience with less sense of incongruity to users while suppressing the amount of computation.

The description of the present embodiment is exemplary in all respects and should not be considered restrictive. The scope of the present invention is indicated by the Claims section, not the embodiment described above. Furthermore, the scope of the present invention includes the scope that is equivalent that of the Claims.

### Effects of the Invention

According to one embodiment of this disclosure, it is possible to realize appropriate sound image localization processing of indirect sounds so that a user can obtain the optimal reverberation experience.

What is claimed is:

1. A sound processing method comprising:
receiving sound information containing a sound signal of a sound source and position information of the sound source;
applying, to the sound signal of the sound source, a first localization process in which a sound image of a direct sound of the sound source is localized based on the position information of the sound source;
applying, to the sound signal of the sound source, a second localization process in which a sound image of an indirect sound of the sound source is localized based on the position information of the sound source;
receiving a condition related to the sound source or a space; and
selecting object-based processing or channel-based processing based on the condition to apply the second localization process.

2. The sound processing method according to claim 1, wherein
the condition includes importance of the sound source or the space, and
the object-based processing or the channel-based processing is selected in accordance with a level of the importance.

3. The sound processing method according to claim 1, wherein
the condition includes at least one of a type of the sound source, sound quality of the sound source, volume of the sound source, or a positional relationship between the sound source and a listening point based on the position information.

4. The sound processing method according to claim 1, wherein
the condition includes a type of the space, or a positional relationship between a wall surface and a listening point.

5. The sound processing method according to claim 1, further comprising
receiving a condition related to processing capacity of a device configured to apply the second localization process, wherein
the selecting of the object-based processing or the channel-based processing is performed further based on the processing capacity.

6. The sound processing method according to claim 5, wherein
the condition related to the processing capacity changes in accordance with processing load of the device.

7. The sound processing method according to claim 1, wherein
the sound information includes sound signals of a plurality of sound sources, position information of each of the plurality of sound sources, and group information on one or more groups which the plurality of sound sources belong to, and
the sound processing method further comprises setting the same condition for sound sources belonging to the same group among the plurality of sound sources.

8. A sound processing device comprising:
a processor configured to
receive sound information containing a sound signal of a sound source and position information of the sound source;
apply, to the sound signal of the sound source, a first localization process in which a sound image of a direct sound of the sound source is localized based on the position information of the sound source;
apply, to the sound signal of the sound source, a second localization process in which s sound image of an indirect sound of the sound source is localized based on the position information of the sound source;
receive a condition related to the sound source or a space; and
select object-based processing or channel-based processing based on the condition to apply the second localization process.

9. The sound processing device according to claim 8, wherein
the condition includes importance of the sound source or the space, and
the processor is configured to select the object-based processing or the channel-based processing in accordance with a level of the importance.

10. The sound processing device according to claim 8, wherein
the condition includes at lease one of a type of the sound source, sound quality of the sound source, volume of the sound source, or a positional relationship between the sound source and a listening point based on the position information.

11. The sound processing device according to claim 8, wherein
the condition includes one of a type of the space, or a positional relationship between a wall surface and a listening point.

12. The sound processing device according to claim 8, wherein
the processor is further configured to receive a condition related to processing capacity of the processor configured to apply the second localization process, and
the processor is configured to select the object-based processing or the channel-based processing further based on the processing capacity.

13. The sound processing device according to claim 12, wherein
the condition related to the processing capacity changes in accordance with processing load of the device.

14. The sound processing device according to claim 8, wherein
the sound information includes sound signals of a plurality of sound sources, position information of each of the plurality of sound sources, and group information on one or more groups which the plurality of sound sources belong to, and
the same condition is set for sound sources belonging to the same group among the plurality of sound sources.

15. A non-transitory computer-readable medium storing a sound processing program that causes a computer to execute a process, the process comprising:
receiving sound information containing a sound signal of a sound source and position information of the sound source;
applying, to the sound signal of the sound source, a first localization process in which a sound image of a direct sound of the sound source is localized based on the position information of the sound source;
applying, to the sound signal of the sound source, a second localization process in which a sound image of an indirect sound of the sound source is localized based on the position information of the sound source;
receiving a condition related to the sound source or a space; and
selecting object-based processing or channel-based processing based on the condition to apply the second localization process.
